(19) United States
(12) Patent Application Publication
(10) Pub. No.: US 2008/0125552 A1
(43) Pub. Date: May 29, 2008

(54) Low-Viscosity Microcapsule Dispersions

(75) Inventors: Petra Schocker, Mannheim (DE); Karl Haberle, Speyer (DE); Valerie Andre, Ludwigshafen (DE); Brigitte Nowakowsky, Speyer (DE)

Correspondence Address: CONNOLLY BOVE LODGE & HUTZ, LLP, P O BOX 2207, WILMINGTON, DE, 19899, US

(73) Assignee: BASF Aktiengesellschaft Patents, Trademarks and Licenses, Ludwigshafen (DE)

(21) Appl. No.: 11/666,855

(22) PCT Filed: Oct. 27, 2005
(86) PCT No.: PCT/EP05/11488

§ 371 Date: May 2, 2007

(30) Foreign Application Priority Data
Nov. 5, 2004 (EP) 04026245.3

(51) Int. Cl. C08G 18/82

(52) U.S. Cl. 525/452

(57) ABSTRACT

The present invention relates to microcapsule dispersions comprising microcapsules in a hydrophobic solvent, wherein the microcapsules have a capsule core, comprising at least one water-soluble organic substance in solution in a hydrophilic solvent, and a capsule shell, obtainable by

a) interfacial polyaddition of at least one di-, oligo- and/or polyisocyanate with at least one reagent carrying at least one isocyanate-reactive group and

b) subsequent aftertreatment of the primary product microcapsules with at least one compound selected from the group consisting of amines, alcohols and amino alcohols having a molecular weight of at least 150 g/mol and

c) if appropriate, subsequent aftertreatment with at least one further aftertreatment reagent.

The present invention relates to microcapsule dispersions comprising microcapsules in a hydrophobic solvent, wherein the microcapsules have a capsule core, comprising at least one water-soluble organic substance in solution in a hydrophilic solvent, and a capsule shell which are obtainable by interfacial polyaddition of at least one di-, oligo- and/or polyisocyanate with at least one isocyanate-reactive reagent and subsequent aftertreatment, and to processes for preparing them. The invention further relates to microcapsules obtainable by removing the hydrophobic solvent from said microcapsule dispersions.

Microcapsules are particles which comprise a capsule core and surrounding said capsule core a capsule shell, also referred to as capsule wall. The various uses depend on the nature of the capsule core. Critical to the properties is also the wall material and the encapsulation process, in the case for example of capsules with controlled release for active ingredients.

Microcapsules find broad application in the case of carbonless copying papers. Thus microcapsules with core oils comprising color formers have been known for a long time. The capsule walls, based on melamine-formaldehyde resin (EP-A-0 026 914) or on polyurea (EP-A-0 535 384), are formed by polycondensation or polyaddition, respectively, at the interfaces of an oil-in-water emulsion.

Conversely to the oil-in-water emulsions, where the oil is the disperse, i.e. discontinuous, phase and the water is the continuous phase, there also known encapsulation processes in which the two phases are reversed. Inverse microencapsulation is a term also used for these processes.

DE-A 101 20 480 describes one such inverse encapsulation. It teaches microcapsules having a capsule core comprising water-soluble substances and a capsule wall made of melamine/formaldehyde resins.

Further, U.S. Pat. No. 5,859,075 teaches microcapsules with diols and polyols as capsule core and with a polyurethane wall, these microcapsules being prepared in paraffins as the continuous phase. The microcapsules thus obtained are suitable as a powder coating component. According to this teaching it is also possible to encapsulate water-sensitive substances by this process.

EP-A-0 148 169 describes microcapsules having a water-soluble core and a polyurethane wall, which are prepared in a vegetable oil. Besides herbicides, water-soluble dyes are among the capsule core materials mentioned.

WO 03/042274 discloses a process for preparing polyurea-based microcapsules having a liquid, suspension-containing or solid capsule core. The capsule walls are formed by an isocyanate/amine system and are further stabilized by the addition of crosslinking components such as, for example, mono- or dialdehydes.

WO 03/015910 relates to microcapsule dispersions comprising microcapsules having a capsule core that comprises water-soluble organic substances, particularly dyes, and a capsule shell which is composed essentially of polyurethane and/or polyurea in a hydrophobic solvent composed of from 50 to 100% by weight of glycerol ester oils and from 0 to 50% by weight of solvents miscible with glycerol ester oils, and to the use thereof in cosmetics.

A problem associated with the use of microcapsule dispersions obtainable by polymerizing di- and/or polyisocyanates is posed by the free—that is, unreacted—isocyanate groups, which can lead to unwanted side reactions or unwanted properties in the product.

DE-A 198 46 650 relates to powder coating slurries comprising microencapsulated particles which contain at least one hydroxyl-containing binder and at least one polyisocyanate crosslinking agent and also water, the particles of the crosslinking agent that may be still in the aqueous phase being stabilized via the isocyanate groups present on their surface, by means of a deactivator which is added to the aqueous phase.

Further, GB 1,142,556 relates to polyurethane—based microcapsules obtainable by reacting isocyanate—functionalized polymers with diamines in aqueous systems. Reagents specified for the aftertreatment include sodium and potassium hydroxide and also 1-hydroxyethyl-2-heptadecenylglyoxalidine.

DE-A 27 06 329 relates to a process for lowering the residual isocyanate content of polyurea microcapsules which comprises treating the polyurea microcapsules, which are formed in oil-in-water systems, with an excess of ammonia or of an amine. Preferred aftertreatment reagents specified are organic dialkylamines in which the alkyl groups each contain 1 to 6 carbon atoms and also ammonia.

A further problem associated with the preparation and use of microcapsule dispersions, particularly those in hydrophobic solvents, is posed by the often high agglomeration tendency of microcapsules, which can lead to high viscosities in the corresponding dispersions.

It was accordingly an object of the present invention to provide microcapsule dispersions comprising microcapsules having a capsule shell and a capsule core comprising at least one organic substance, in a hydrophobic solvent, which feature low viscosity and a very low level of free, unreacted isocyanate groups.

Microcapsule dispersions have now been found which comprise microcapsules in a hydrophobic solvent, wherein the microcapsules have a capsule core, comprising at least one water-soluble organic substance in solution in a hydrophilic solvent, and a capsule shell, obtainable by
a) interfacial polyaddition of at least one di-, oligo- and/or polyisocyanate with at least one reagent carrying at least one isocyanate-reactive group and
b) subsequent aftertreatment of the primary product microcapsules with at least one compound selected from the group consisting of amines, alcohols and amino alcohols having a molecular weight of at least 150 g/mol and
c) if appropriate, subsequent aftertreatment with at least one further aftertreatment reagent.

The capsules comprise a capsule shell and a capsule core. The capsule core comprises at least one water-soluble organic substance in solid form and/or, as a result of its preparation, in the form of solution in a suitable solvent. In the context of the present invention the capsule core preferably comprises a water-soluble organic substance, preferably in the form of a solution in a hydrophilic solvent. Particular preference is given to aqueous solutions of the at least one water-soluble organic substance.

A reactant for the purposes of this specification is a compound containing at least one isocyanate-reactive group. Preferred reactants are those whose isocyanate-reactive groups are OH, NH and/or NH₂ groups which are able to react with isocyanate groups. Preferred reactants among these, in turn, are the primary amines.

Particularly preferred reactants are the polyfunctional amines such as, for example, the polyvinylamines, the polyoxyalkylenamines and/or the polyethylenimines. Particularly preferred reactants of these are those having a number-average molecular weight of from about 600 to about 380 000 g/mol. In accordance with the invention these reactants may also be used in the form of mixtures, particularly in the form of mixtures with at least one alkyldiamine having 2 to 10, preferably 2 to 6 carbon atoms.

The basic principle of microencapsulation is based on what is called interfacial addition polymerization or interfacial polyaddition. With interfacial polyaddition, in a first process step, the materials for encapsulation and the reactant, as it is known, are dissolved, for example, in a hydrophilic solvent, after which a hydrophobic solvent is added and the system is processed to an emulsion. The continuous phase of the emulsion normally includes surface-active substances, preventing coalescence of the droplets. Within this emulsion the solvent is the discontinuous, disperse phase and the hydrophobic solvent is the continuous phase. Where the hydrophilic solvent is water, the term water-in-oil emulsion is also illustrative. The emulsified droplets possess a size that corresponds approximately to the size of the subsequent microcapsules. To form the capsule wall in a second process step the emulsion is mixed with the di-, oligo- and/or polyisocyanate capable of wall forming. The reactant is capable of reacting with the isocyanate in solution in the continuous phase, at the interface between the discontinuous and continuous phases, to form the polymeric capsule wall.

The next step of the process (step b) comprises what is called the aftertreatment of the freshly prepared capsule dispersion. In this step, under temperature and residence time control, the reaction of the isocyanate functions of the di-, oligo- and/or polyisocyanate(s) introduced that have not reacted with the OH, NH and/or NH₂ functions of the reactant(s) employed is completed. For the aftertreatment according to step b) in accordance with the invention at least one compound is added selected from the group consisting of amines, alcohols and amino alcohols having a molecular weight of at least 150 g/mol. The free isocyanate groups still present are inventively reacted with the selected aftertreatment reagent, i.e., an amine, alcohol or amino alcohol or mixture thereof. Preference is given to using aftertreatment reagents which have a number-average molecular weight of from about 200 to about 70 000 g/mol, more preferably from about 200 to about 20 000 g/mol, in particular from about 300 to about 10 000 g/mol and, with very particular preference, from about 400 to about 5000 g/mol. Mention may be made by way of example of aftertreatment reagents which can be used in accordance with the invention of the following compounds: aminated fatty alcohols such as stearylamine, oleylamine, arachidylamine and laurylamine, for example, and aminated C₃₀-C₅₀ alcohols such as cetylamine, nonatrien-1-amine, isotride-cylamine and behenylamine, for example.

The following can additionally be used successfully as aftertreatment reagents in step b):
C₁₀-C₅₀ alkoxy-1-propanamines, such as lauryloxypropylamine, stearyloxypropylamine, isotridecyloxypropylamine and tallowalkyl γ-aminopropyl ethers, for example,
ω-amino fatty acids/esters such as ω-aminolauric acid and ω-aminolauric esters, for example,
methyl tetraglycol amine, ethyl tetraglycol amine and N-octyl-6-aminohexanamide,
fatty alkyl-1,3-diaminopropanes such as arachidyl-1,3-diaminopropane and behenyl-1,3-diaminopropane, for example.

Further suitable aftertreatment reagents of step b) are the polyoxyalkylenemonoamines, examples being those of the general formula (I)

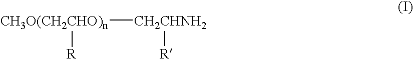

where R and R′ independently of one another are H or CH₃ and n is chosen so as to give a compound that has a molecular weight within the abovementioned ranges. As examples of this class of compound mention may be made of the following: XTJ-505 (M-600), XTJ-506 (M-1000), XTJ-507 (M-2005) and JEFFAMINE® M-2070 (in each case from Huntsman).

Further aftertreatment reagents of step b) for preparing the microcapsule dispersions of the invention are the polyisobutylenamines of the general formula (II)

C(CH₃)₃—[CH₂—C(CH₃)₃]ₓ—CH₂—CH(CH₃)—(CH₂)₂—NH₂ II,

where x is an integer and is chosen so as to give a polyisobutylenamine that falls within the desired molecular weight range. Preferably x is an integer from about 5 to about 25, more preferably from about 10 to about 20.

Examples thereof that may be mentioned as polyisobutylenamines which can be used successfully in accordance with the invention include the following: Kerocom® PIBA 03 (polyisobutylenamine, number-average molecular weight approximately 1000 g/mol, BASF Aktiengeselischaft). Further suitable polyisobutylenamines are specified in EP-A 0 244 616.

Polyisobutylenamines, as described in the last-mentioned reference, are obtainable, for example, by hydroformylation and subsequent reductive amination of the corresponding polyisobutylenes, which in turn can be prepared in different chain lengths.

Aftertreatment reagents in step b) that are particularly preferred in the context of the present invention are the aforementioned polyisobutylenamines, particularly those having a number-average molecular weight of from about 300 to about 10 000 g/mol, in particular from about 400 to about 5000 g/mol.

Further particularly preferred aftertreatment reagents in step b) are the aminated C₃₀-C₅₀ alcohols such as myricylamine or melissylamine, for example, the polyoxyalkylenemonoamines, N,N-ditridecylpropylendiamine and the C₁₀-C₅₀, especially C₃₀-C₅₀, alkoxy-1-propanamines.

The selected aftertreatment reagent of step b) is used usually in an amount of from about 0.005 to about 1.0 mol, preferably from about 0.1 to about 0.7 mol and more preferably from about 0.02 to about 0.3 mol per kg of the dispersion prepared according to step a), depending on the amount of free—i.e., unreacted—isocyanate groups in the dispersion prepared.

Through the use of the stated compounds having a number-average molecular weight of at least 150 g/mol for aftertreating the freshly prepared microcapsules it is possible to obtain microcapsule dispersions which are distinguished by advantageous properties, in particular by a reduced viscosity, as compared with microcapsule dispersions treated with low molecular weight aftertreatment reagents.

A further advantage of the microcapsule dispersions obtainable in this way is that free, as yet unreacted isocyanate groups react with the stated aftertreatment reagents and so the molecular weight, in particular of remnants of isocyanates still present freely in solution, is significantly increased. As a result it is possible, among other things, to lessen the toxic potential of the said isocyanates, which are present as an impurity.

By a hydrophilic solvent is meant not only water but also aqueous mixtures which in addition to water contain up to 20% by weight of a water-miscible organic solvent such as C₁ to C₄ alkanols, especially methanol, ethanol or isopropanol, or a cyclic ether such as tetrahydrofuran. A preferred hydrophilic solvent is water.

Suitable hydrophilic solvents are additionally ethylene glycol, glycerol, polyethylene glycols and butylene glycol and also mixtures thereof and also mixtures thereof with water or with the aqueous mixtures listed above. Preferred hydrophilic solvents are mixtures of these solvents with water.

Examples of suitable hydrophobic solvents include mineral oils, mineral waxes, branched and/or unbranched hydrocarbons and triglycerides of saturated and/or unsaturated, branched and/or unbranched C₈-C₂₄ alkanecarboxylic acids. Further substances suitable as hydrophobic solvents include the synthetic, semisynthetic or natural oils such as olive oil, palm oil, almond oil or mixtures; oils, fats or waxes, esters of saturated and/or unsaturated, branched and/or unbranched C₃-C₃₀ alkanecarboxylic acids and saturated and/or unsaturated, branched and/or unbranched C₃-C₃₀ alcohols of aromatic carboxylic acids and saturated and/or unsaturated, branched and/or unbranched C₃-C₃₀ alcohols, by way of example isopropyl myristate, isopropyl stearate, hexyldecyl stearate, oleyl oleate; and also synthetic, semisynthetic and natural mixtures of such esters, such as jojoba oil, alkylbenzoate or silicone oils such as cyclomethicone, dimethylpolysiloxane, diethylpolysiloxane, octamethylcyclotetrasiloxane, for example, and also mixtures thereof, or dialkyl ethers, such as linear or branched, symmetric or unsymmetric dialkyl ethers having 6 to 22 carbon atoms per alkyl group, for example. Ring opening products of epoxidized fatty acid esters with polyols and/or aliphatic and/or naphthenic hydrocarbons may also be suitable.

Preferred hydrophobic solvents are esters, particularly esters of polyols, more preferably pure glycerol ester oils. Particularly preferred glycerol ester oils in this context are C₆-C₁₂ fatty acid triglycerides or mixtures thereof, especially octanoic and decanoic triglycerides and mixtures thereof. One preferred octanoyl glyceride/decanoyl glyceride mixture is, for example, Miglyol® 812 from Sasol.

In one preferred embodiment the hydrophobic solvents used in accordance with the invention are pure glycerol ester oils or glycerol ester oil mixtures with a concentration of from about 50 to about 100% by weight. By glycerol ester oils are meant esters of saturated or unsaturated fatty acids with glycerol. Mono-, di- and triglycerides and also their mixtures are suitable. Fatty acid triglycerides are preferred.

The hydrophobic solvent is composed, for example, of from 50 to 100% by weight, preferably from 70 to 100% by weight, more preferably from 90 to 100% by weight of glycerol ester oils and from 0 to 50% by weight, preferably from 0 to 30% by weight, more preferably from 0 to 10% by weight of solvents miscible with glycerol ester oils. Particular preference as hydrophobic solvent is given to glycerol ester oils, which are used individually or in their mixtures.

Examples of oils miscible with glycerol ester oils include the following:
hydrocarbon oils, such as liquid paraffin, purcellin oil, perhydrosqualene and solutions of microcrystalline waxes in these oils,
animal or vegetable oils, such as sweet almond oil, avocado oil, calophyllum oil, lanolin and derivatives thereof, castor oil, horse oil, pig oil, sesame oil, olive oil, jojoba oil, karite oil and hoplostethus oil,
mineral oils with an atmospheric pressure distillation start point at about 250° C. and a distillation end point at 410° C., such as vaseline oil, for example, and
esters of saturated or unsaturated fatty acids, such as alkyl myristates, e.g., isopropyl, butyl or cetyl myristate, hexadecyl stearate, ethyl or isopropyl palmitate and cetyl ricinoleate.

Further suitable compounds which are miscible with glycerol ester oils are silicone oils, such as dimethylpolysiloxane, methylphenylpolysiloxane and the silicone glycol copolymer, fatty acids and fatty alcohols or waxes such as carnauba wax, candellila wax, beeswax, microcrystalline wax, ozokerite wax and Ca, Mg and Al oleates, myristates, linoleates and stearates.

The compounds specified as hydrophobic solvents can each be used individually or as mixtures with one another.

The addition of perfume oils to mask the odor of the polymers is generally unnecessary. If desired, however, the cosmetic formulations may nevertheless include perfume oils. Examples that may be mentioned of perfume oils include mixtures of natural and synthetic fragrances. Natural fragrances are, for example, extracts of blossoms (e.g., lily, lavender, rose, jasmine, neroli, ylang-ylang), stems and leaves (e.g., geranium, patchouli, petit grain), fruit (e.g., aniseed, coriander, caraway, juniper), fruit rinds (e.g., bergamot, lemon, orange), roots (e.g., mace, angelica, celeriac, cardamom, costus, iris, calmus), woods (e.g., pinewood, sandalwood, guajak wood, cedarwood, rosewood), herbs and grasses (e.g., tarragon, lemon grass, sage, thyme), needles and twigs (e.g., spruce, fir, pine, mountain pine), resins and balsams (e.g., galbanum, elemi, benzoine, myrrh, olibanum, opoponax). Also suitable are animal raw materials, such as amber grease, zibet and castoreum.

Typical synthetic fragrance compounds which can be used if desired are, furthermore, compounds of the type of the esters, ethers, aldehydes, ketones, alcohols and hydrocarbons. Fragrance compounds of the ester type are, for example, benzyl acetate, phenoxyethyl isobutyrate, 4-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate and benzyl salicylate. The ethers include, for example, benzyl ethyl ether; the aldehydes include, for example, the linear alkanals having 8 to 18 carbon atoms, citral, citronellal, citronellyloxyacetaldehyde, cyclamenaldehyde, hydroxycitronellal, lilial and bourgeoal; the ketones include, for example, the ionones, α-isomethyl ionone and methyl cedryl ketone; the alcohols including anethole, citronellol, eugenol, isoeugenol, geraniol, linalool, phenylethyl alcohol and terpineol; and the hydrocarbons include, for example, the terpenes and balsams. Preference is given, however, to using mixtures of different fragrances which in unison produce an appealing fragrance note. Essential oils of low volatility as well, usually used as aroma components, are suitable as perfume oils, examples being sage oil, chamomile oil, oil of clove, balm oil, mint oil, cinnamon leaf oil, lime blossom oil, juniper berry oil, vertiver oil, olibanum oil, galbanum oil, labdanum oil and lavandin oil. Preference is given to using bergamot oil, dihydromyrcenol, lilial, lyral, citronellol, phenylethyl alcohol, α-hexylcinnamaldehyde, geraniol, benzylacetone, cyclamenaldehyde, linalool, boisambrene forte, ambroxane, indol, hedione, sandelice, lemon oil, mandarin oil, orange oil, allyl amyl glycolate, cyclovertal, lavandin oil, clary sage oil, β-damascone, geranium oil bourbon, cyclohexyl salicylate, Vertofix Coeur, lso-E-Super, Fixolide NP, Evernyl, iraldein gamma, phenylacetic acid, geranyl acetate, benzyl acetate, rose oxide, Romillat, Irotyl and Floramat, alone or in the form of mixtures.

The capsule core of the microcapsules of the invention comprises at least one, i.e., one or a mixture of two or more, generally from about 2 to 5 different water-soluble organic substance(s). Preferably the capsule core comprises one water-soluble organic substance. By a water-soluble organic substance is meant a carbon-based compound which is at least partly soluble in water. The organic substance must have a greater affinity to the hydrophilic phase than to the hydrophobic phase. This is generally ensured when the substance has a solubility in the hydrophilic solvent at room temperature of at least 1 g/l. Preferably the organic substances have a solubility of at least 20 g/l in the hydrophilic solvent.

The water-soluble organic substances are, for example, water-soluble dyes, water soluble vitamins like for example Vitamin B6, agrochemicals, flavors, pharmaceutical actives, fertilizers or cosmetic actives. Depending on the thickness and/or degree of crosslinking of the capsule wall, influenced by the chosen process conditions and the amount of the ingredients, the capsules are impermeable or of low permeability to the water-soluble organic substances.

The term “dye” here and below embraces organic compounds and salts of organic compounds and also charge transfer complexes of organic compounds with a chromophore which has an absorption maximum in the wavelength range from 400 to 850 nm and therefore evokes to the human eye an impression of color (conventional dyes) and which may also itself emit light in the visible range (florescent dyes). Dyes for the purposes of this invention also include compounds having an absorption maximum in the range from 250 to 400 nm which on irradiation with UV light emit fluorescence radiation in the visible range (optical brighteners). Dyes in the sense of this invention further include organic compounds which absorb light of wavelength <400 nm and deactivate it without radiation (UV stabilizers).

In general the water-soluble dyes contain ionic functional groups which improve the solubility in the aqueous solvent. The modification carried out may be cationic or anionic. Suitable substituents are, for example, sulfonic, carboxylic and phosphoric acid radicals and also ammonium and alkylammonium radicals.

Dyes suitable in accordance with the invention embrace different classes of dye with different chromophores, examples being monoazo and bisazo dyes, triarylmethane dyes, metal complex dyes, such as phthalocyanine dyes, quinophthalones and methine and azamethine dyes. Preferred dyes among these are the monoazo and bisazo dyes, quinophthalones, methine and azamethine dyes and metal complex dyes, such as phthalocyanine dyes.

Mention may be made by way of example of the following numbers from the Colour Index:

Direct Yellow 4, 5,10, 11, 50, 127, 137, 147, 153; Acid Orange 7, 8; Direct Orange 15, 34, 102; Direct Red 81, 239, 252-255; Direct Violet 9, 51; Acid Blue 9, 86; Direct Blue 199, 218, 267, 273, 279, 281; Acid Black 194, 208, 210, 221; Direct Black 19, 161,170 and 171;

Basic Red 1, Basic Red 14, Basic Blue 7, Basic Blue 11, Basic Blue 26, Basic Violet 1, Basic Violet 4, Basic Violet 10 etc.; reactive dyes such as Reactive Red 120, Reactive Red 2, and so on.

The dyes further include complexes of basic and acidic dyes and complexes of anionic and cationic dyes, an example being the complex of chrysoidine base and metanil yellow acid.

In accordance with the invention the dyes also include optical brighteners which are at least partly soluble in water.

The organic dyes also include, by definition, UV-absorbing compounds (UV stabilizers) which deactivate the absorbed radiation nonradiatively. Compounds of this kind are frequently used as UV absorbers in sun protection products. They include derivatives of p-aminobenzoic acid, in particular its esters; 2-phenylbenzimidazole-5-sulfonic acid and salts thereof, salicylates, cinnamates, benzophenones, 2-phenylbenzimidazole-4-sulfonic acid and salts thereof, urocanic acid, salts thereof and esters thereof, benzoxazoles, benzotriazoles, benzylidenecamphor and its derivatives, 3,3′-(1,4-phenylendimethine)-bis(7,7-dimethyl-2-oxobicyclo[2.2.1]heptane-1-sulfonic acid) and salts thereof, 2-hydroxy-4-methoxy-benzophenon-5-sulfonic acid and salts thereof, dimethoxyphenylglyoxalic acid and salts thereof, 3-(4′sulfobenzyliden)-bornan-2-one and salts thereof, 2,2′-(1,4-phenylen)-bis-1H-benzimidazole-4,6-disulfonic acid and salts therof.

Likewise highly suitable are Colour Index dyes used in cosmetology, such as 42045, 42051, 42080, 42090, 42735, 44045, 61585, 62045, 73015, 74180, bromothymol blue, caramel, 10316, 13015, 18690, 18820, 18965, 19140, 45350, 47005, 75100, lactoflavin, 10020, 42053, 42100, 42170, 44090, 59040, 61570, 75810, bromocresol green, 14270, 15510, 15980, 15985, 16230, 20170, 40215, 14700, 14720, 14815, 15620, 16035, 16185, 16255, 16290, 17200, 18050, 18130, 18736, 24790, 27290, 45100, 45220, 45380, 45405, 45410, 45425, 45430, 75470, beetroot red, anthocyans, Acid Red 195, Black 20470, 27755, 28440, 50420, 42510, 42520, 45190, 60725 and 60730.

As preferred dyes mention may be made by way of example of the dyes having the Colour Indices (C.l.) 15510, 15985, 16255, 17200, 19140, 20170, 42053, 42090, 45350, 45380, 45410, 47005, 60725, 61570 and 75470.

Depending on the color intensity and solubility of the dye the microcapsule generally contains 0.1% by weight, based on the hydrophilic solvent, preferably from 1 to 50% by weight, more preferably from 5 to 40% by weight and in particular from 5 to 30% by weight of at least one dye.

The water-soluble organic substances to be encapsulated in accordance with the invention may be used individually or in the form of mixtures of two or more different water-soluble organic substances. By this means it is possible if desired to obtain, in accordance with the invention, microcapsule dispersions which contain either a single water-soluble organic substance or a mixture thereof, such as a mixture of different dyes, for example.

Depending on the nature of the reactants used, the capsule wall of the invention is composed essentially of polyurea and/or polyurethane, which represents the respective reaction product, i.e., the product of the interfacial polyaddition in step a), of the reagent used in accordance with the invention carrying at least one isocyanate-reactive group with the di-, oligo- and/or polyisocyanate(s) employed.

Suitable are di-, oligo- and/or polyisocyanates, such as aliphatic, cycloaliphatic, araliphatic, aromatic and heterocyclic di- and polyisocyanates, as are described by W. Siefken in Justus Liebigs Annalen der Chemie, 562, pages 75 to 136, for example ethylene diisocyanate, 1,4-tetramethylene diisocyanate, 1,6-hexamethylene diisocyanate, 1,12-dodecane diisocyanate, cyclobutane 1,3-diisocyanate, cyclohexane 1,3- and 1,4-diisocyanate and any mixtures of these isomers, 1-isocyanato-3,3,5-trimethyl-5-isocyanatomethylcyclohexane, as described, for example, in DE-B 1 202 785 and U.S. Pat. No. 3,401,190, 2,4- and 2,6-hexahydrotolylene diisocyanate, and any mixtures of these isomers, hexahydro-1,3- and -1,4-phenylene diisocyanate, perhydro-1,4′-and-4,4′-diphenylmethane diisocyanate, 1,3- and 1,4-phenylene diisocyanate, 2,4- and 2,6-tolylene diisocyanate, and any mixtures of these isomers, diphenylmethane 2,4′- and 4,4′-diisocyanate, naphthylene 1,5-diisocyanate, triphenylmethane 4,4′,4″-triisocyanate, polyphenylpolymethylene polyisocyanates, as obtained by aniline-formaldehyde condensation and subsequent phosgenation and described, for example, in GB patents 874 430 and 848 671, m- and p-isocyanatophenylsulfonyl isocyanates according to U.S. Pat. No. 3,454,606, perchlorinated aryl polyisocyanates, as are described, for example, in DE-B 1 157 601, polyisocyanates containing carbodiimide groups, as are described in DE patent 1 092 007 (=U.S. Pat. No. 3,152,162), diisocyanates as described in U.S. Pat. No. 3,492,330, polyisocyanates containing allophanate groups, as are described in GB patent 761 626 and the published NL patent application 7 102 524, polyisocyanates containing isocyanurate groups, as described, for example, in U.S. Pat. No. 3,001,973, in the German patents 1 022 789, 1 222 067 and 1 027 394, and in German laid-open patents 1 929 034 and 2 004 048, polyisocyanates containing urethane groups, as described, for example, in BE patent 752 261 or in U.S. Pat. No. 3,394,164, polyisocyanates containing acylated urea groups according to German patent 1 230 778, polyisocyanates containing biuret groups, as described, for example, in German patent 1 101 394 and in GB patent 889 050, polyisocyanates prepared by telomerization reactions, as are described, for example, in U.S. Pat. No. 3,654,106, polyisocyanates containing ether groups, as are mentioned, for example, in GB patents 965 474 and 1 072 956, in U.S. Pat. No. 3,567,763 and in German patent 1 231 688, reaction products of the abovementioned isocyanates with acetals according to German patent 1 072 385, and polyisocyanates containing polymeric fatty acid radicals in accordance with U.S. Pat. No. 3,455,883.

It is also possible to use the distillation residues containing isocyanate groups which form during the industrial preparation of isocyanate, optionally dissolved in one or more of the abovementioned polyisocyanates. It is further possible to use any mixtures of the abovementioned polyisocyanates.

Suitable modified, aliphatic isocyanates are, for example, those based on hexamethylene 1,6-diisocyanate, m-xylylene diisocyanate, 4,4′-diisocyanatodicyclohexylmethane and isophorone diisocyanate, which contain at least two isocyanate groups per molecule.

Also suitable are, for example, polyisocyanates based on derivatives of hexamethylene 1,6-diisocyanate with a biuret structure as described in DE-B 1 101 394, DE-B 1 453 543, DE-A 1 568 017 and DE-A 1 931 055.

It is also possible to use polyisocyanate-polyuretonimines, as arise as a result of the carbodiimidization of hexamethylene 1,6-diisocyanate, containing biuret groups, with organophosphorus catalysts, where carbodiimide groups formed primarily react with further isocyanate groups to give uretonimine groups.

It is also possible to use isocyanurate-modified polyisocyanates containing more than two terminal isocyanate groups, e.g., those whose preparation on the basis of hexamethylene diisocyanate is described in DE-A 2 839 133. Other isocyanurate-modified polyisocyanates can be obtained analogously thereto.

It is also possible to use mixtures of said isocyanates, e.g., mixtures of aliphatic isocyanates, mixtures of aromatic isocyanates, mixtures of aliphatic and aromatic isocyanates, in particular mixtures which optionally comprise modified diphenylmethane diisocyanates. The di- and/or polyisocyanates described here can also be used as mixtures with di- and polycarbonyl chlorides, such as sebacoyl chloride, terephthaloyl chloride, adipoyl dichloride, oxaloyl dichloride, tricarballyloyl trichloride and 1,2,4,5-benzenecarbonyl tetrachloride, with di- and polysulfonyl chlorides, such as 1,3-benzenesulfonyl dichloride and 1,3,5-benzenesulfonyl trichloride, phosgene and with dichloro- and polychloroformic esters, such as 1,3,5-benzenetrichloroformate and ethylenebischloroformate.

Preferred isocyanates are biuretic hexamethylene diisocyanate, optionally in a mixture with 4,4′-diphenylmethane isocyanate and optionally 2,4-diphenylmethane isocyanate, trimerized hexamethylene diisocyanate optionally in a mixture with 4,4′-diphenylmethane diisocyanate and optionally 2,4-diphenylmethane diisocyanate.

Further suitable diisocyanates are the alkylbenzene diisocyanates and alkoxybenzene diisocyanates specified in DE-A 3 105 776 and 3 521 126, including those in the form of their biuret isocyanate uretdione oligomers.

Preferred di- or polyisocyanates are 4,4′-diphenylmethane diisocyanate, the mixtures of monomeric diphenylmethane diisocyanates and oligomeric diphenylmethane diisocyanates (polymer MDI), tetramethylene diisocyanate, tetramethylene diisocyanate trimers, hexamethylene diisocyanate, hexamethylene diisocyanate trimers, isophorone diisocyanate trimer, 4,4′-methylenebis(cyclohexyl) diisocyanate, xylylene diisocyanate, tetramethylxylylene diisocyanate, dodecyl diisocyanate, lysine alkyl ester diisocyanate, where alkyl is C₁ to C₁₀, 2,2,4- or 2,4,4-trimethyl-1,6-hexamethylene diisocyanate, 2-butyl-2-ethylpentamethylene diisocyanate, 1,4-diisocyanato cyclohexane or 4-isocyanatomethyl-1,8-octamethylene diisocyanate.

Further preference is given to di- or polyisocyanates having NCO groups of different reactivity, such as 2,4-tolylene diisocyanate (2,4-TDI), 2,4′-diphenylmethane diisocyanate (2,4′-MDI), triisocyanatotoluene, isophorone diisocyanate (IPDI), 2-butyl-2-ethylpentamethylene diisocyanate, 2-isocyanatopropyl-cyclohexyl isocyanate, 3(4)-isocyanatomethyl-1-methylcyclohexyl isocyanate, 1,4-diisocyanato-4-methylpentane, 2,4′-methylene-bis(cyclohexyl) diisocyanate and 4-methylcyclohexane 1,3-diisocyanate (H-TDI). Particular preference is also given to isocyanates whose NCO groups are initially equally reactive, but in which a reactivity decrease in the case of the second NCO group can be induced as a result of a first addition of an alcohol or amine onto an NCO group. Examples thereof are isocyanates whose NCO groups are coupled via a delocalized electron system, e.g., 1,3- and 1,4-phenylene diisocyanate, 1,5-naphthylene diisocyanate, diphenyl diisocyanate, tolidine diisocyanate or 2,6-tolylene diisocyanate.

A group of isocyanates which is additionally preferred in the context of step a) of the process of the invention is represented by the following compounds: tetramethylene diisocyanate, hexamethylene diisocyanate, dodecamethylene diisocyanate, 1,4-diisocyanatocyclohexane, 4,4′-di(isocyanatocyclohexyl)methane, trimethylhexane diisocyanate, tetramethylhexane diisocyanate, 1-isocyanato-3,3,5-trimethyl-5-(isocyanatomethyl)cyclohexane (IPDI), 2,4-tolylene diisocyanate and 2,6-tolylene diisocyanate, tetramethylxylylene diisocyanate, 2,4′-diisocyanatodiphenylmethane and 4,4′-diisocyanatodiphenylmethane.

Particular preference is given to oligo- or polyisocyanates which can be prepared from the stated di- or polyisocyanates or mixtures thereof by linking by means of urethane, allophanate, urea, biuret, uretdione, amide, isocyanurate, carbodiimide, uretonimine, oxadiazinetrione or iminooxadiazinedione structures. Preference in turn among these is given to oligo- or polyisocyanates which can be prepared from the stated di- or polyisocyanates or mixtures thereof by linking by means of urethane, isocyanurate, allophanate, urea or biuret structures.

Reactants of step a) of the process of the invention which can be reacted inventively with the stated di-, oligo- and/or polyisocyanates are those containing at least one isocyanate-reactive group. Preferred isocyanate-reactive groups that may be mentioned are OH, NH and NH₂ groups. Accordingly the stated reactants are amines, alcohols and/or amino alcohols, each of which can be used individually or in the form of mixtures of, for example, from about 2 to about 5, preferably 2 to 3 different reactants.

Suitable reagents containing at least one isocyanate-reactive group of step a) are, in particular, the primary amines. Particularly suitable reagents are amines containing at least two amino groups, selected from the group consisting of primary and secondary amino groups. Examples thereof are diamines, such as diaminoethane, diaminopropanes, diaminobutanes, diaminohexanes, piperazine, 2,5-dimethyl-piperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane, preferably diaminoethane, 1,3-diaminopropane and 1,4-diaminobutane.

The amines can also be used in blocked form, e.g., in the form of the corresponding ketimines (see, e.g., CA-A 1 129 128), ketazines (cf., e.g., U.S. Pat. No. 4,269,748) or amine salts (see U.S. Pat. No. 4,292,226).

Examples of amino alcohols are ethanolamine, diethanolamine and triethanolamine. In principle, water can also act as reactant by undergoing addition onto an NCO group and subsequent CO₂ elimination, so generating an amino group which can then react with an NCO group with crosslinking.

Reactants preferred in the context of the present invention, i.e., reagents containing at least one isocyanate-reactive group, are the polyfunctional amines, particularly those having an average molecular weight of from about 600 to about 380 000 g/mol, preferably from about 600 to about 300 000 g/mol, more preferably from about 600 to about 100 000 g/mol and very preferably from about 800 to about 70 000 g/mol. These compounds can each be used singly or as mixtures with one another. The term “polyfunctional amine” embraces, for the purposes of the present invention, polyvinylamines of the general formula (Ill),

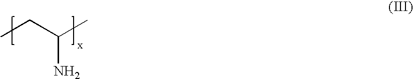

### Polyethylenimine (polyethylenamine) of the general formula (IV) or (V) respectively,

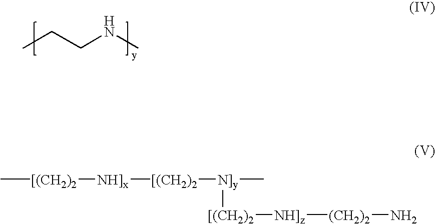

and/or polyoxyalkylenamines of the general formula (VI) to (VIII)

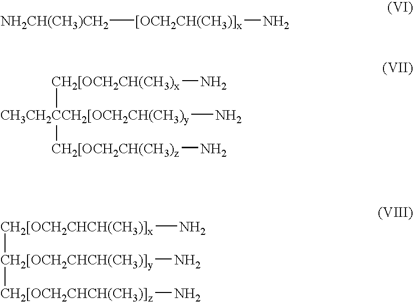

where the indices x, y and z in the formulae (III) to (VIII) are integers each selected independently of one another such that the respective polyfunctional amines have molecular weights situated within the ranges indicated above. Examples that may be mentioned of the class of compound of the polyoxyalkylenamines are the JEFFAMINE® products such as JEFFAMINE® D-230, JEFFAMINE® D-400, JEFFAMINE® D-2000, JEFFAMINE® T-403, XTJ-510 (D-4000), XTJ-500 (ED-600), XTJ 501 (ED-900), XTJ-502 (ED-2003), XTJ 509 (T-3000) and JEFFAMINE® T-5000.

Polyfunctional amines preferred in the context of the present invention are the polyvinylamines of the formula (III) and the branched polyethylenimines of the formula (V), especially the polyvinylamines of the formula (III). Polyvinylamines of this kind are obtainable, for example, by hydrolyzing the corresponding polyvinylformamides of the formula (IX)

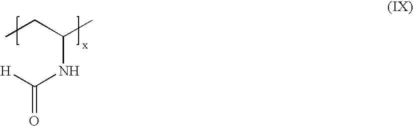

Where the polyvinylamine used in accordance with the invention is the product of the hydrolysis of a polyvinylformamide it may still contain polyvinylformamide of the formula (IX), depending on the extent or completeness of the hydrolysis that has occurred. For the purposes of the present invention it is preferred to use hydrolysis products having a degree of hydrolysis of from about 60 to about 100% (mol/mol) which therefore contain about 40 to about 0% (mol/mol) of the polyvinylformamide used originally. Preference is given to using hydrolysis products which have a degree of hydrolysis of from about 80 to about 100%, more preferably from about 90 to about 100% and with particular preference from about 95 to about 100%.

The polyethylenimines likewise preferred as polyfunctional amines in accordance with the invention are obtainable by methods known per se to the skilled worker, as described, for example, in Römpp Chemie Lexikon, 9th edition, 1992.

The stated polyfunctional amines may each be used individually or in the form of mixtures of about 2 to about 5 different amines from among those stated, for preparing the microcapsule dispersions of the invention.

In one preferred embodiment they are used together with alkyldiamines having 2 to 10, preferably 2 to 6 carbon atoms. Suitable alkyldiamines are for example aliphatic alkyldiamines having 2 to 10, preferably 2 to 6, carbon atoms, such as, for example, ethylenediamine, propylenediamine, butylenediamine and/or hexamethylenediamine, preferably ethylenediamine and/or hexamethylenediamine. Likewise suitable are the cyclic alkyldiamines such as, for example, piperazine, 2,5-dimethylpiperazine, amino-3-aminomethyl-3,5,5-trimethylcyclohexane (isophoronediamine, IPDA), 4,4′-diaminodicyclohexylmethane and/or 1,4-diaminocyclohexane. The stated alkyldiamines may also each be used individually or in the form of mixtures of the compounds stated.

In one preferred embodiment of the preparation of the microcapsule dispersions of the invention the selected polyfunctional amine, in particular the selected polyvinylamine, is used in the form of mixtures with one of the stated alkyldiamines or with a mixture of the stated alkyldiamines. In that case the mixing ratio is advantageously selected such that about 20 to about 65%, preferably about 30 to about 60%, in particular about 40 to about 55% of the amino groups in the mixture originate from the selected alkyldiamine or mixture of selected alkyldiamines.

The amount of isocyanates to be used according to the invention varies within the scope customary for interfacial polyaddition processes. Thus generally 20 to 150% by weight, preferably 40 to 150% by weight, of isocyanate are used based on the discontinuous phase provided for the encapsulation (hydrophilic solvent+water-soluble substance). Good shear stabilities of the capsules are observed from amounts as low as 40% by weight. Amounts above 150% by weight are possible, but do not generally lead to more stable capsule walls.

The theoretical amount of the isocyanate necessary for wall forming is calculated from the amount of reactive amino and/or hydroxyl groups of the reactant component(s) used. These quantitative ratios are usually expressed by equivalent weights.

$$\begin{matrix}equivalent {weight}_{isocyanate} = \frac{42}{NCO content {}^{ *} )} \times 100 \\ {}^{ *} ) = e . g . , to be dtermined titrimetrically ( DIN 53 \; 185 ) \\ equivalent {weight}_{reactant} = \frac{molar {weight}_{reactant}}{\begin{matrix}number of reactive \\ groups in the molecule\end{matrix}}\end{matrix}$$

Reaction of all of the NCO groups present in the oil phase requires at least theoretically equal numbers of OH, NH₂ and/or -NH groups. It is therefore advantageous to use the isocyanate and the polyfunctional amine and optionally selected alkyldiamine in the ratio of their equivalent weights. It is, however, likewise possible to deviate from the stoichiometrically calculated amount of crosslinker either downward, since, during interfacial polyaddition processes, a side reaction of the isocyanate with the water present in excess cannot be ruled out, or to use an excess of the reactant component, because such an excess is uncritical, and because, particularly in the case of the polyfunctional amines used, steric reasons mean that generally not all of the amino groups are reacted.

In particular, therefore, the reactants are used in an amount between about 50 and 250% by weight of the theoretically calculated amount. This amount is preferably between about 90 and 200% by weight, in particular between about 105 and 170% by weight, based on the theoretically calculated amount.

The present invention further provides a process for the preparation of the microcapsule dispersion according to the invention, in which an emulsion of the hydrophilic solvent in the hydrophobic solvent is prepared with the aid of a surface-active substance, where the hydrophilic phase comprises the water-soluble organic substance and the NH or NH₂ group-carrying reactants which react with di- and/or polyisocyanate groups, and di- and/or polyisocyanates are added to the emulsion.

In order to obtain a stable emulsion, surface-active substances such as protective colloids and/or emulsifiers are required. Usually, surface-active substances which mix with the hydrophobic phase are used.

Preferred protective colloids are linear block copolymers with a hydrophobic structural unit of length ≧50 Å, alone or in mixtures with other surface-active substances. The linear block copolymers are given by the formula

C_{w}(B—A—B_{y})ₓD_{z}

in which w is 0 or 1, x is a part of 1 or more, y is 0 or 1 and A is a hydrophilic structural unit, having a solubility in water at 25° C. of ≧1% by weight and a number-average molecular weight of from 200 to 50 000 g/mol, which is bonded covalently to the B blocks, and B is a hydrophobic structural unit having a number-average molecular weight of from 300 to 60 000 g/mol and a solubility in water at 25° C. of <1% by weight and can form covalent bonds to A; and in which C and D are end groups which, dependently on one another, may be A or B. The end groups may be identical or different and are dependent on the preparation process.

Examples of hydrophilic groups are polyethylene oxides, poly(1,3-dioxolane), copolymers of polyethylene oxide or poly(1,3-dioxolane), poly(2-methyl-2-oxazoline), poly(glycidyltrimethylammonium chloride) and polymethylene oxide.

Examples of hydrophobic groups are polyesters in which the hydrophobic moiety is a steric barrier ≧50 Å, preferably ≧75 Å, in particular ≧100 Å. The polyesters are derived from components such as 2-hydroxybutanoic acid, 3-hydroxybutanoic acid, 4-hydroxybutanoic acid, 2-hydroxycaproic acid, 10-hydrodecanoic acid, 12-hydroxydodecanoic acid, 16-hydroxyhexadecanoic acid, 2-hydroxyisobutanoic acid, 2-(4-hydroxyphenoxy)propionic acid, 4-hydroxyphenylpyruvic acid, 12-hydroxystearic acid, 2-hydroxyvaleric acid, polylactones of caprolactone and butyrolactone, polylactams of caprolactam, polyurethanes and polyisobutylenes.

The linear block copolymers contain both hydrophilic units and hydrophobic units. The block polymers have a molecular weight above 1000 g/mol and a length of the hydrophobic moiety of ≧50 Å calculated according to the law of cosines. These sizes are calculated for the extended configuration, taking into consideration the bond lengths and angles given in the literature. The preparation of these units is general knowledge. Preparation processes are, for example, condensation reaction of hydroxy acid, condensations of polyols, such as diols, with polycarboxylic acids, such as dicarboxylic acids. Also suitable is the polymerization of lactones and lactams, and the reaction of polyols with polyisocyanates. Hydrophobic polymer units are reacted with the hydrophilic units, as generally known, for example by condensation reaction and coupling reaction. The preparation of such block copolymers is described, for example, in U.S. Pat. No. 4,203,877, to which reference is expressly made. The proportion of linear block copolymer is preferably 20-100% by weight of the total amount of surface-active substance used.

Suitable surface-active substances are also the emulsifiers customarily used for water-in-oil emulsions, for example
C₁₂-C₁₈ sorbitan fatty acid esters,
esters of hydroxystearic acid and C₁₂-C₃₀ fatty alcohols,
mono- and diesters of C₁₂-C₁₈ fatty acids and glycerol or polyglycerol,
condensates of ethylene oxide and propylene glycols,
oxypropylenated/oxyethylenated C₁₂-C₂₀ fatty alcohols,
polycyclic alcohols, such as sterols,
aliphatic alcohols with a high molecular weight, such as lanolin,
mixtures of oxypropylenated/polyglycerylated alcohols and magnesium isostearate,
succinic esters of polyoxyethylated or polyoxypropylenated fatty alcohols,
the lanolates and stearates of magnesium, calcium, lithium, zinc and aluminum, optionally as a mixture with hydrogenated lanolin, lanolin alcohol, or stearic acid or stearyl alcohol.

Emulsifiers of the Span® series have proven particularly advantageous. These are cyclized sorbitol, sometimes polyesterified with a fatty acid, where the base structure can also be substituted by further radicals known from surface-active compounds, for example by polyethylene oxide. Examples which may be mentioned are the sorbitan esters with lauric, palmitic, stearic and oleic acid, such as Span® 80 (sorbitan monooleate), Span) 60 (sorbitan monostearate) and Span® 85 (sorbitan trioleate).

In one preferred embodiment oxypropylenated/oxyethylenated C₁₂-C₂₀ fatty alcohols are used as mixing component with further surface-active substances. These fatty alcohols usually have 3 to 12 ethylene oxide and/or propylene oxide units.

Preference is given to using C₁₂-C₁₈ sorbitan fatty acid esters as emulsifier. These can be used individually, in their mixtures and/or as mixtures with other abovementioned types of emulsifier. The proportion of sorbitan fatty acid esters is preferably 20- 100% by weight of the total amount of surface-active substance used.

In one preferred embodiment a mixture of surface-active substances comprising the above-defined linear block copolymers and C₁₂-C₁₈ sorbitan fatty acid esters is chosen.

With particular preference a mixture of surface-active substances comprising the linear block copolymers, C₁₂-C18 sorbitan fatty acid esters and oxypropylenlated/oxyethylenated C₁₂-C₂₀ fatty alcohols are chosen.

Preference is given to those mixtures containing 20 to 95% by weight, in particular 30 to 75% by weight, of linear block copolymer and 5 to 80% by weight, in particular 25 to 70% by weight, of C₁₂-C1₁₈ sorbitan fatty acid esters, based on the total amount of surface-active substance. The proportion of oxypropylenated/oxyethylenated C₁₂-C₂₀ fatty alcohol is preferably 0 to 20% by weight.

Particular preference is given to mixtures of surface-active substances containing essentially 30 to 50% by weight of linear block copolymer, 40 to 60% by weight of C₁₂-C₁₈ sorbitan fatty acid esters and 2 to 10% by weight of oxypropylenated/oxy-ethylenated C₁₂-C₂₀ fatty alcohols, based on the total amount of surface-active substance.

The optimum amount of surface-active substance is influenced firstly by the surface-active substance itself and secondly by the reaction temperature, the desired microcapsule size and the wall materials. The optimally required amount can be readily determined by simple serial experiments. For preparing the emulsion the surface-active substance is generally used in an amount of 0.01 to 10% by weight, preferably 0.05 to 5% by weight and in particular 0.1 to 2% by weight, based on the hydrophobic phase.

To prepare the microcapsules according to the invention, according to one preferred embodiment, a solution of water-soluble organic substance, a dye for example, and at least one polyfunctinal amine as described above and, if appropriate, one or more different alkyldiamines in the hydrophilic solvent can be added to the hydrophobic solvent. With the help of the surface-active substance, a stable emulsion is prepared with stirring. According to a likewise preferred variant, the water-soluble organic substances and the reactant(s) are added only to the stable emulsion or during the emulsifying step. The isocyanate can then be metered into such an emulsion. Generally, this starts the interfacial polyaddition or polycondensation and thus the formation of the wall.

The selected isocyanate component can be added continuously or discontinuously. The isocyanate component is successfully added continuously, in which case the rate of addition can be held constant or varied during the reaction. In one particularly preferred embodiment of the preparation of the microcapsule dispersions of the invention a procedure is followed in which the di- and/or polyisocyanates are added to the emulsion continuously and at a rate which decreases as reaction progresses, i.e., in gradient mode. This preferred preparation process makes it possible in particular to provide the microcapsule dispersions of the invention with high encapsulation efficiencies in terms of the water-soluble organic substance to be encapsulated. This means that by this preparation process, advantageously, dispersions are obtained of microcapsules whose walls are distinguished by particularly low permeability to the encapsulated water-soluble organic substance.

The interface reaction can proceed, for example, at temperatures in the range from −3 to +70° C., preference being given to working at 15 to 65° C.

Depending on the size of the capsules to be prepared, the core material is dispersed in a known manner. For the preparation of large capsules, dispersion using effective stirrers, in particular propeller or impeller stirrers, suffices. Small capsules, particularly if the size is to be less than 50 μm, require homogenizing or dispersing machines, it being possible for these devices to be provided with or without forced-flow means.

The homogenization can also be carried out using ultrasound (e.g., Branson Sonifier II 450). For homogenization by means of ultrasound, suitable equipment is, for example, that described in GB 2250930 and U.S. Pat. No. 5,108,654.

The capsule size can be controlled via the rotational speed of the dispersion device/homogenization apparatus and/or using suitable thickeners such as polyisobutylenes (Glissopal®, BASF Aktiengesellschaft) in dependence of their concentration molecular weight thereof, i.e., via the viscosity of the continuous oil phase, within certain limits. In this connection, as the rotational speed increases up to a limiting speed, the size of the dispersed particles decreases. Further thickeners that can be used include weathered aluminas such as, for example Bentone® 38.

In this connection it is important that the dispersion devices are used at the start of capsule formation. In the case of continuously operating devices with forced flow, it is advantageous to pass the emulsion through the shear field a number of times.

In accordance with the invention the freshly prepared microcapsule dispersions of step b) are admixed as described above with an aftertreatment reagent having a molecular weight of at least 150 g/mol.

Subsequently the microcapsule dispersions of the invention may also if desired be subjected to a further aftertreatment in step c). Suitable reagents for such aftertreatment are compounds other than the aftertreatment reagents used in step b) and generally of low molecular weight that are capable of completing the reaction between the isocyanate component(s) used and the reactants used having at least one isocyanate-reactive group and/or the selected aftertreatment reagent having a molecular weight of at least 150 g/mol, and/or of reacting with unreacted isocyanate functions. Particularly suitable for this purpose are amines and/or amino alcohols, such as, for example, 2-aminomethylpropanol, propylamine, butylamine, pentylamine, hexylamine, 2-aminocyclohexanol and octylamine. A preferred aftertreatment reagent is 2-aminomethylpropanol.

Using the process according to the invention it is possible to prepare microcapsule dispersions with a microcapsules content of from 5 to 50% by weight. The microcapsules are individual capsules. If suitable conditions are chosen during the dispersion it is possible to produce capsules with an average particle size in the range from about 0.1 to 200 μm and above. Preference is given to capsules with an average particle size of from about 0.1 to 50 μm, in particular from about 0.1 μm to about 30 μm, most preferred from about 0.1 μm to about 10 μm. The average particle diameter is the z-average particle diameter, determined by Fraunhofer diffraction with Mie correction for counting individual particles. It is usually determined using a Malvern Mastersizer S. The very narrow size distribution of the capsules is a particular advantage.

The microcapsule dispersions according to the invention can be incorporated into cosmetic compositions in a known manner. Incorporation into the cosmetic composition takes place by the procedures customary for this purpose and known per se to the skilled worker, usually by stirring and homogenizing into the other constituents of the cosmetic composition.

Examples of cosmetic compositions which are formulated as decorative cosmetic compositions are compositions for the treatment of facial skin, in particular in the eye area, such as kohl pencils, eyeliner pencils, eyebrow pencils, eyeshadows, cream blusher, powder blusher, foundation, make-up, e.g. stage make-up, lipsticks.

Further cosmetic compositions that may be mentioned include compositions comprising UV-absorbing compounds, such as, for example, sun protection products such as sun protection creams or sun protective sticks, for example.

In the case of cosmetic compositions which consist exclusively of oils or fats, in particular those which have a solid form, e.g. pencils, such as kohl pencils, eyeliner pencils, eyebrow pencils, stick stage make-up, lipsticks and the like, and in the case of coarse or fine powder cosmetic compositions, such as eyeshadows and cream blusher or loose powder blusher, preference is given to using microcapsule dispersions.

The amount of microcapsules in the cosmetic composition is guided primarily by the desired color impression which the decorative cosmetic composition is to have. Depending on the nature of the cosmetic composition and the desired color impression, the microcapsules content of the cosmetic composition is in the range from 0.1 to 50% by weight, based on the total weight of the cosmetic composition.

The present invention further provides microcapsules obtainable by removing the hydrophobic solvent from the microcapsule dispersions of the invention. This can be done by any methods which are known to the skilled worker and appear suitable: for example, by filtration or extraction of the microcapsule dispersions of the invention with a suitable solvent such as heptane, for example, with subsequent drying of the microcapsules.

The microcapsules obtainable in this way are also suitable for all of the uses referred to above for the microcapsule dispersions of the invention - for example, for incorporation into cosmetic compositions.

The examples below serve to illustrate the invention without restricting it in any way whatsoever:

The viscosities were measured using a modular compact rheometer from Paar Physica (MCR100). The temperature was 23° C., the diameter of the plate 50 mm, and the distance between the two plates 1 mm. The rotational measurement was carried out at shear rates γ from 10⁻² to 10² s⁻¹. The data recorded were processed using the US200 software in Ostwald evaluation mode. The data reported were in each case those obtained at a shear rate of 0.1 s⁻¹ and 10⁻¹. The capsule diameter was determined visually at 500 times magnification using a microscope from Olympus (BX 51).

The residue isocyanate content of the hydrophobic solvent was determined following derivatization of the samples with 9-(methylaminomethyl)anthracen (approximately 200 mg of sample per 0.28 mg of reagent, in toluene) and dilution with acetonitrile aliquots and by means of reversed-phase HPLC (acetonitrile/aqueous phosphoric acid, gradient mode, RP8 as stationary phase) using fluorescence detection (ex. 254 nm, em. 426 nm). Quantification was by means of an external standard derivatized in the same way as the samples.

The molar weight of the fragments in the hydrophobic solvent aftertreatment with amines was determined by means of GPC at 35° C. The columns used were Mini-Mix C 1×3 μm×4.6 mm×250 mm, Mini-Mix B 2×5 μm×4.6 mm×250 mm (from Polymer Laboratories). The reference used was a polystyrene standard from Polymer Laboratories. The mobile phase is tetrahydrofuran. The fragments were detected by UVNIS spectroscopy (λ=254 nm).

The volatile constituents of the Kerocom® PIBA 03 (BASF Aktiengesellschaft) used in example 1 were first removed on a rotary evaporator at a bath temperature of 140° C. and a vacuum of 15 mbar.

### EXAMPLE 1

### Preparation of a Microcapsule Dispersion with Aftertreatment with Polyisobutyleneamine (PIBA)

A 4 I stirred vessel was charged with a solution of 1.2 g of Span® 80 (sorbitan monooleate, Roth GmbH), 4.7 g of Span® 85 (sorbitan monooleate, Roth), 1.2 g of Cremophor® A6 [75% by weight ceteareth-6 (ethoxylated cetyl alcohol) 25% by weight stearyl alcohol, BASF Aktiengesellschaft] and 4.7 g of Arlacel® P135 (PEG-30 dipolyhydroxystearate, Atlas Chemie) in 1295.6 g of Miglyol® 812 (decanoyl/octanoyl glyceride; Sasol). Then a solution of 8.8 g of ethylenediamine (Merck KGaA, 99%), 30.0 g of polyvinylamine (Lupamin® 5095 SF, dialyzed, molecular weight about 45 000 g/mol, degree of hydrolysis>90%, BASF Aktiengesellschaft), and 47.0 g of the dye C.I. 42090, BASF Aktiengesellschaft) in 313.3 g of water was added and dispersion was carried out for four minutes using a disperser (Pendraulic stirrer type LD-50) at a rotational speed of 4000 rpm (RZR 2102, Heidolph). The water-in-oil emulsion obtained in this way was admixed with stirring at a rate of 2000 rpm (RZR 2102, Heidolph) with a solution of 196.2 g of Basonat® TU 75 E (polyfunctional tolylene diisocyanate (TDI) adduct of TDI with polyol, 75% strength by weight in ethyl acetate, BASF Aktiengesell-schaft) in 1080.8 g of Miglyol® over the course of 90 minutes in a linearly descending gradient. After the end of the addition the dispersion was heated to 60° C. over the course of 15 minutes and stirred for a further 60 minutes. Thereafter the reaction mixture was cooled to room temperature over the course of 15 minutes, admixed with 153 g of Kerocom® PIBA 03 (polyisobutylenamine, molecular weight about 1000 g/mol, BASF Aktiengesellschaft) and stirred at room temperature for 40 minutes. Finally 5.1 g of 2-aminomethylpropanol (Merck, 95%) were added to the reaction mixture, which was stirred at room temperature for 40 minutes more. The dispersion obtained was milky blue and according to microscopic evaluation contained individual capsules predominantly 1-5 μm in diameter. The viscosity was 4.5 Pas (0.1 s⁻¹) or 0.5 Pas (10 s⁻¹). The residual quantity of isocyanate (amount of unreacted isocyanate groups) was less than 15 ppm. The GPC-determined molar weight of the fragments remaining in the hydrophobic solvent of the dispersion obtained was about 3000 g/mol. The solids content of the dispersion was 24% by weight.

### COMPARATIVE EXAMPLE 1

### Preparation of a Microcapsule Dispersion without Aftertreatment with Polyisobutylenamine (PIBA):

A microcapsule dispersion was prepared in the same way as in example 1. After the reaction mixture had cooled to room temperature only 5.1 g of 2-aminomethylpropanol (Merck, 95%) were added and the mixture was stirred at room temperature for 40 minutes more. The dispersion obtained was milky blue and according to microscopic evaluation contained individual capsules predominantly 1-5 μm in diameter. The viscosity was 21.6 Pas (0.1 s⁻¹) or 0.9 Pas (10 s⁻¹). The residual quantity of isocyanate was less than 15 ppm. The HPLC-determined molar weight of the fragments remaining in the hydrophobic solvent was about 1000 g/mol. The solids content was 20% by 1 5 weight.

1-21. (canceled)

22. A microcapsule dispersion comprising microcapsules in a hydrophobic solvent, wherein said microcapsules comprises a capsule core and a capsule shell, said capsule core comprising at least one water-soluble organic substance in solution in a hydrophilic solvent, prepared by the process of:
a) reacting at least one di-, oligo- and/or polyisocyanate with at least one reagent carrying at least one isocyanate-reactive group by interfacial polyaddition;
b) aftertreating the primary product microcapsules with at least one compound selected from the group consisting of amines, alcohols, and amino alcohols having a molecular weight of at least 150 g/mol; and
c) optionally aftertreating the aftertreated primary product microcapsules of b) with at least one additional aftertreatment reagent.

23. The microcapsule dispersion of claim 22, wherein said at least one isocyanate-reactive group is an NH₂, NH, and/or OH group.

24. The microcapsule dispersion of claim 22, wherein said at least one isocyanate-reactive group is a primary amine.

25. The microcapsule dispersion of claim 22, wherein said at least one compound of b) has a molecular weight of from 200 to 20,000 g/mol.

26. The microcapsule dispersion of claim 22, wherein said at least one compound of b) has a molecular weight of from 400 to 5,000 g/mol.

27. The microcapsule dispersion of claim 22, wherein said at least one compound of b) is selected from the group consisting of polyisobutylenamines, polyoxyalkylenemonoamines, and C₃₀-C₅₀ alkoxy-1-propanamines.

28. The microcapsule dispersion of claim 22, wherein c) in not optional.

29. The microcapsule dispersion of claim 22, wherein said hydrophilic solvent is water.

30. The microcapsule dispersion of claim 22, wherein said at least one water-soluble organic substance is a dye.

31. The microcapsule dispersion of claim 23, wherein said at least one reagent of a) is a polyfunctional amine.

32. The microcapsule dispersion of claim 31, wherein said at least one polyfunctional amine is a polyvinylamine.

33. The microcapsule dispersion of claim 31, wherein said polyfunctional amine is in a mixture with at least one alkyldiamine having 2 to 10 carbon atoms.

34. The microcapsule dispersion of claim 22, wherein the at least one reagent of a) has a number-average molecular weight of from 600 to 380,000 g/mol.

35. The microcapsule dispersion of claim 22, wherein the at least one additional aftertreatment reagent of c) is an amine and/or an amino alcohol.

36. The microcapsule dispersion of claim 22, wherein said hydrophobic solvent comprises from 50 to 100% by weight of glycerol ester oils and from 0 to 50% by weight of solvents miscible with glycerol ester oils.

37. The microcapsule dispersion of claim 22, wherein said hydrophobic solvent comprises glycerol ester oils.

38. The microcapsule dispersion of claim 22, wherein said at least one isocyanate of a) is an oligo- and/or polyisocyanate-containing urethane, isocyanurate, allophanate, urea, and/or biuret structure.

39. The microcapsule dispersion of claim 22, wherein said at least one di-, oligo- and/or polyisocyanate is selected from the group consisting of tetramethylene diisocyanate; hexamethylene diisocyanate; dodecamethylene diisocyanate; 1,4-diisocyanatocyclohexane; 4,4′-di(isocyanatocyclohexyl)methane; trimethylhexane diisocyanate; tetramethylhexane diisocyanate; 1-isocyanato-3,3,5-trimethyl-5-(isocyanatomethyl)cyclohexane (IPDI); 2,4-tolylene diisocyanate; 2,6-tolylene diisocyanate, tetramethylxylylene diisocyanate; 2,4′-diisocyanatodiphenylmethane; and 4,4′-diisocyanatodiphenylmethane.

40. A process for preparing a microcapsule dispersion comprising microcapsules in a hydrophobic solvent, wherein said microcapsules comprises a capsule core and a capsule shell, said capsule core comprising at least one water-soluble organic substance in solution in a hydrophilic solvent, comprising the steps of:
a) reacting at least one di-, oligo- and/or polyisocyanate with at least one reagent carrying at least one isocyanate-reactive group by interfacial polyaddition;
b) aftertreating the primary product microcapsules with at least one compound selected from the group consisting of amines, alcohols, and amino alcohols having a molecular weight of at least 150 g/mol; and
c) optionally aftertreating the aftertreated primary product microcapsules of b) with at least one additional aftertreatment reagent.
wherein in step a), an emulsion of a hydrophilic solvent in a hydrophobic solvent is prepared with the aid of a surface-active substance and the hydrophilic phase of said emulsion comprises the at least one water-soluble organic substance and the reagent carrying at least one isocyanate-reactive group, and wherein said di-, oligo- and/or polyisocyanates are added to said emulsion.

41. The process according to claim 40, wherein said di-, oligo- and/or polyisocyanates are added to said emulsion continuously at a rate which decreases as reaction progresses.

42. Microcapsules prepared by removing the hydrophobic solvent from the microcapsule dispersion of claim 22.
